(19) United States
(12) Patent Application Publication
(10) Pub. No.: US 2001/0047348 A1
(43) Pub. Date: Nov. 29, 2001

(54) Consumer driven content media duplication system

(76) Inventor: Lemuel Davis, Encinitas, CA (US)

Correspondence Address: Angenehm Law Firm, Ltd., P.O. Box 48755, Coon Rapids, MN, 55448-0755, US

(21) Appl. No.: 09/775,935

(22) Filed: Feb. 1, 2001

Related U.S. Application Data
(60) Provisional application No. 60/179,627, filed on Feb. 1, 2000.

(51) Int. Cl. G06F 7/00

(52) U.S. Cl. 707/1; 705/1

(57) ABSTRACT

A media provider, including a job-control master computer system which manages duplication jobs via directing each duplication job to a processing job queue of a particular recording cluster; and a plurality of media file clusters each containing a media file master server, a processing job queue, a job recording queue and at least one media-recording client; the media file master server obtaining a duplication job from the processing job queue, acquiring files for the duplication job and transferring such information to the recording queue, the media recording client retrieving a duplication job and duplicating the consumer defined collection of files and/or uniquely modified or newly created set of files together with the unique digital identification number on a recording medium.

The present invention, which claims priority from U.S. Provisional Patent Application no. 60/179,627 filed Feb. 1,2000, and entitled CONSUMER DRIVEN CONTENT MEDIA DUPLICATION SYSTEM, relates to a system and method used to produce media recordings and more particularly to a system and method used to produce a plurality of individually customized media recordings.

### FIELD OF THE INVENTION

### BACKGROUND OF THE INVENTION

Media content takes many forms, including music, movies, video games; computer software and various other formats. Products based on these types of recordings generally have recorded content predetermined by the manufacturer and may or may not comport with the desires of the consumers. For instance, a consumer may prefer specific songs from a variety of artists, perhaps the top ten pop songs of the year, but find themselves forced into purchasing ten separate CD's to obtain copies of all the songs. Another example would be a preference for a PG version of a popular movie where objectionable scenes are removed or altered. In some cases, consumers may not be able to find their preferred choices, such as finding a good selection of video games featuring characters of their own ethnicity or using their language.

These various forms of media are further segregated so that a person who wishes to purchase media containing a specific content needs to shop in a variety of locations. While some stores may carry all types, their selection is limited by available floor space. A person often needs to go to more specialized stores to obtain hard to locate selections. Low volume, small market selections will likely be impossible to find. The time and effort in finding the desired media is time consuming for the consumer.

Many worthy artists and other producers of media content have difficulty in getting their work accepted by media distributors because of the high costs for distribution and duplication. Distributors want a sure bet and are more likely to continue to work with previously successful artists than with unknowns or with those addressing only a small market.

Certain media formats are unavailable or are available only on a limited basis. For instance, movie titles are hard to find in the higher quality SVHS and Video8 videotape formats since the larger market is for VHS tapes.

The prior art in large scale recording systems has allowed only predefined content to be duplicated. More recently, systems have become available allowing a selection of various content selections to be placed on a single recording, but these systems have generally been limited to a specific type of media and do not allow for modification or generation of content.

What is needed is a means for media producers to profitably produce and distribute low volume content on a variety of media types. Preferably, the consumer can choose those specific selections that they desire, whether popular or not, and create their own personalized CDs or other forms of media. Further, this process and equipment should allow for custom modification of content, allow one of a kind new content to be included, and provide a user specific serial number to each product such that the user may be held responsible should illegal copies be found.

### SUMMARY OF THE INVENTION

The present invention solves the aforementioned problems and adds a new dimension for personalization previously not available by providing an architecture capable of supporting thousands of simultaneous yet unique recordings on various types of media. The invention utilizes a hierarchical distributed computer system having multiple networks to maximize fast transfer of a large volume of data while maximizing resource utilization and production of media products. Included are a programmable multimedia user interface; a database server containing multiple databases; a media file customization server; a digital ID generator; a job control master computer; a media file archival server and a plurality of media file clusters. Each of these components interact to allow a consumer to determine which selections he/she would like recorded on a recording medium from a wide array of choices, to specify which customization options to apply to the media files prior to recording and to provide the finished product in expedient time.

The user interface may be any mechanism having multimedia capabilities and allowing for programmable processes to be applied. The preferred interface is a website accessed via commonly available web browers or devices that allow the user to preview media files, select media files, interactively choose customization options, upload media files and perform purchase transactions. The preferred web browsers are those allowing downloading of applets such as those written in Java. Such purchase and any uploaded files may be recorded by the database server.

The database server is capable of holding multiple databases containing data or information about a plurality of customers, data or information about a plurality of media files and data or information about each recording. The customer information may include the customers name, shipping address, billing address, media preferences, past purchases, payment information, and uploaded media files. The media database includes information about each media file available for purchase including cost, length, available formats, ratings, credits, ownership, and royalty requirements, as well as representative samples of each media file to be used for customer previews and selection of customization options. The recording database is used to store information about each recording made by the system and to store a reference key to the customer record for the purchaser of the recording.

The digital ID generator generates unique digital identification numbers that reference purchases in the recording information database and may be used to generate a digital identifier found on completed recordings. The digital ID is uniquely created to be different from all other IDs and includes enough information to allow the media content producer, the customer and the specific recording to be uniquely identified.

The media file customization server may be used in those embodiments requiring a high level of computing capacity to allow the user to interactively preview customization requests. An example of such use would be those applications having computer generated imagery of complex 3 dimensional objects.

The job-control master computer system manages the recording jobs. Specifically, it directs each recording job to a processing job queue of a particular recording cluster. The recording cluster may be chosen based upon resource utilization and data transfer efficiency principles within the system.

The plurality of media file clusters may each contain a media file master server, optionally one or more media generation clients, at least one media-recording client and at least one packaging printer client.

The media file master servers maintain several media files with storage allocation based on an associated priority determined primarily by popularity. Less popular files will be assigned a lower priority and will be more likely to be removed to make space for other files from other recording jobs. Media files are also stored temporarily in the local storage for the client computers in a media file cluster. Up to four queues are maintained on the media file master: the processing job queue previously mentioned, a generation job queue, a recording job queue and a packaging printer queue.

The media file master server obtains a recording job from the processing job queue. Files for the recording job may be acquired from the media file master's local storage if already present or the media file archival server if not. Finally, the media file master server sends the recording job with associated files to either the media generation client queue for computational work or to the recording client queue. The media generation client retrieves a generation client job with associated file references from the generation client queue and computes new media files based on the customer's specifications for modification or generation of files. The media recording client retrieves a recording client job with associated file references from the recording queue. The media recording client duplicates the files together with the unique digital identification number created by the digital ID generator onto a recording medium. Prior to the completion of the recording, a job is entered into packaging printer queue so that the packaging materials and labels will be available at about the same time as the recording is completed by the recording client.

### DESCRIPTION OF THE FIGURES

FIG. 1 shows a flow chart of the major components of the present invention;

FIG. 2 shows a flow chart of a portion of the present invention

FIG. 3 shows a flow chart of a portion of the present invention;

FIG. 4 shows a flow chart of a portion of the present invention;

FIG. 5 shows a flow chart of a portion of the present invention;

FIG. 6 is a chart explaining the interaction of the components within the recording mechanism; and

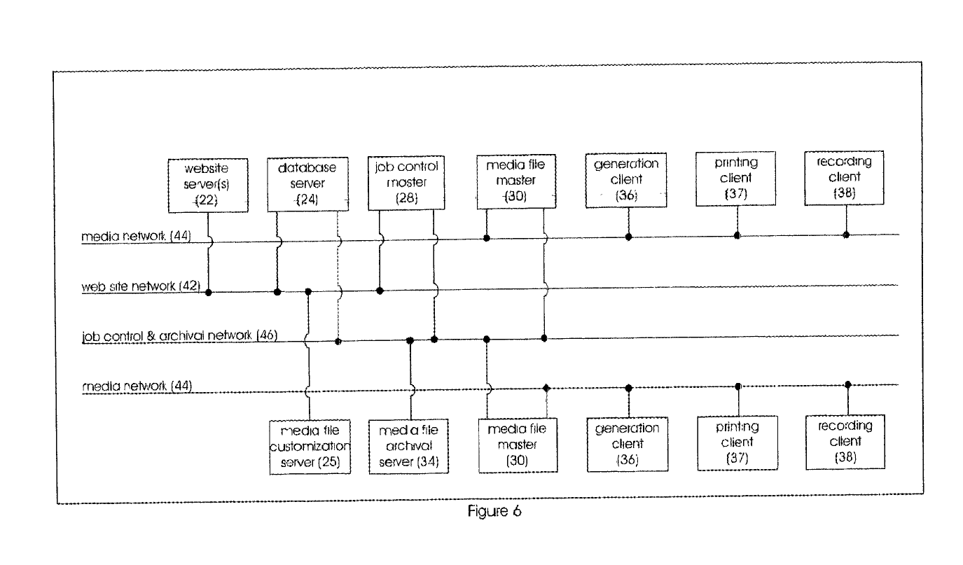

FIG. 7 shows a flow chart of a portion of the present invention.

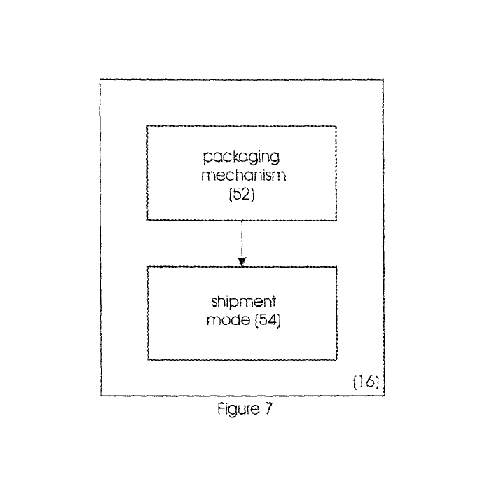

### DETAILED DESCRIPTION

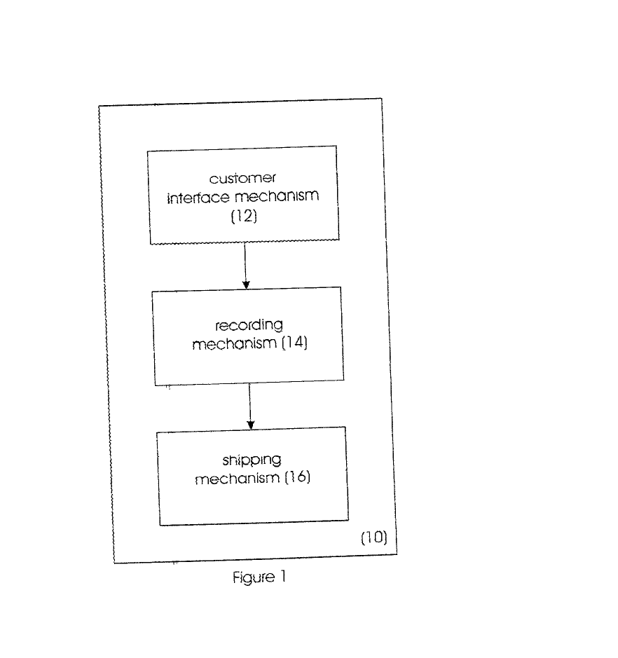

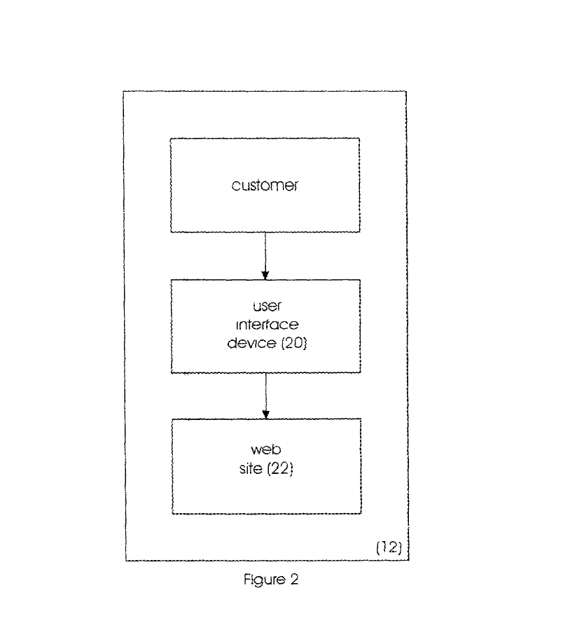

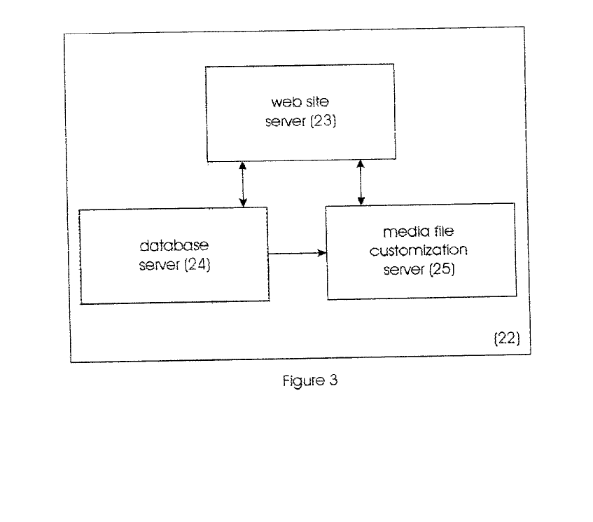

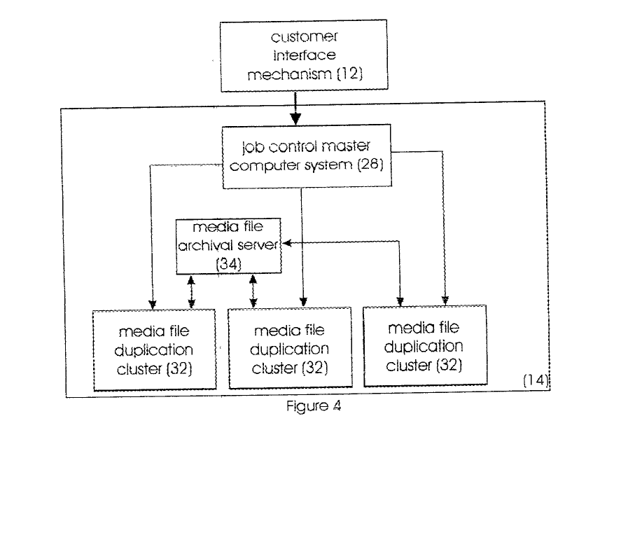

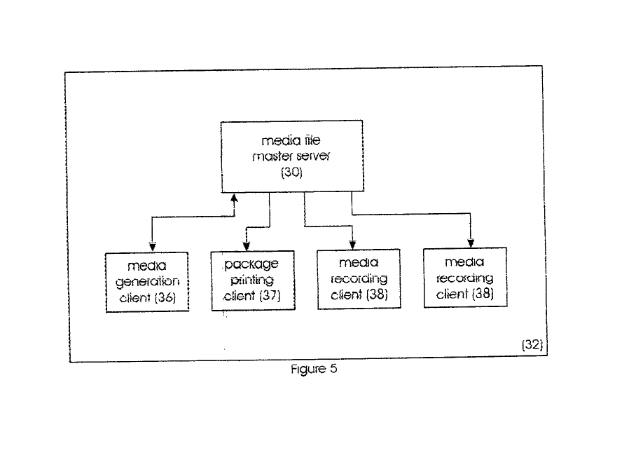

The present inventive device 10, shown in FIGS. 1 through 5, includes a customer interface mechanism 12, a recording mechanism 14, and a shipping mechanism 16.

The customer interface mechanism 12 includes a user interface device 20, a web site 22, a media file customization server 23, and a database server 24. The user interface device 20, the web site 22, and the database server 24 will be described in more detail below. The components of the customer interface mechanism 12 function collectively to allow a customer to select and preview media files, interactively choose and preview customization options, perform secure purchase transactions and possibly arrange for shipment of the completed item. After the content files have been selected, possibly modified, possibly created and recorded, the media item is packaged, labeled and shipped to the customer as will be described later. The purchase process causes customer specific data to be entered into the customer database residing on the database server 13.

The user interface device 20 may be any interactive device having Internet or Intranet access, such as personal computers running Microsoft Internet Explorer or Netscape Navigator web browsers. The user interface device 20 must support HTML 2.0 or greater, downloadable applets such as those written in Java, streaming media companion applications such as Microsoft Media Player, multimedia plugins such as Macromedia's Flash, and uploadable files. The web site 22 may be any which sells items containing some form of media content such as computer games, videos, music, computer software or other current or future forms of items containing media content. The web site 22 and associated web pages will allow the customer to preview, select and purchase a custom set of media content files on one or more types of recordable media, such as recordable CDROMS, recordable DVDs or video tapes. The server for the web site 22 may be any suitable computer system or set of systems with network access having suitable size and performance for the requirements determined by the numbers of hits and support for heavy media utilization. The web site 22 server software may be any suitable server software such as Apache or Microsoft Site Server allowing access to the database server 13 described below. The server must be configured to support secure purchase transactions utilizing a secure digital certificate such as those from Verisign, to support streaming media players, to support downloadable applets such as those created with Java, to support uploading of files and to support multimedia web browser plugins such as Flash.

The web pages associated with the web site 22 may be designed to support varying types of user interaction depending upon the types of media being sold and the associated customization options. Where media files are selected without customization options, the web site 22 may simply provide media file samples for previewing via downloading or streaming to a streaming media player. Where possible, customization options will be previewed using a browser applet in order to lessen the computational capacity requirements for the web site 22. For instance, Java applets can be used to manipulate or create images, short animations and simple 3 dimensional geometries. There are two cases where applets, cannot be used. In one case the customization processing requirements may be too high or involve too much data to be preformed by an applet. In the other case, the customization processing may involve confidential proprietary algorithms such that users may not be allowed direct access to the code implementing the algorithms. In both cases, the customization processing may be handled by the media file customization server 23. The types of processing allowed are further described in relation to the media generation clients 38.

The database server 13 may utilize any modern relational database system that is capable of holding data or information about a plurality of customers, that is capable of holding media files and providing them to database clients over a network in a timely manner, that can provide high performance while supporting multiple simultaneous database client requests, that provides support for development using modern programming and scripting languages and that includes a means for interfacing to web servers. The are a number of relational database software packages that are suitable such as Oracle and Microsoft SQL Server. The database host computer system may be any computer system of sufficient size and performance running a modern operating system such as Windows 2000 or UNIX. In large installations, the database server processing may be distributed across multiple host computers. The database server must maintain three primary databases: the customer database, the media file database and the recording database.

Communication between computer systems within the customer interface mechanism 12 occurs over the web site network 42. Systems containing media file data to be recorded are isolated from this network to help decrease the chances of media files being pirated. Additionally, media file transfers can quickly saturate a network, thus the isolation helps improve the performance of the web site 22. The web site network 42 may be based on any commonly available network standard such as 100 Mbps Ethernet.

The customer inputs information to the customer database component of the database server 13 via the web site 22. The information may include name, shipping address, billing address, media preferences, past purchases, computer hardware profile of the user's system, payment information, uploaded media files and other information. The uploaded media files are utilized to create customized media recordings as will be described later.

The media database residing on the database server 13 includes information about each media file available for purchase including cost, length, available formats, ratings, credits, ownership, number of purchases, and royalty payment requirements, as well as representative samples of each media file to be used for customer previews and selection of customization options. A system operator inputs the required information into the media database when a media file or set of files is installed and made available for purchase. The information about the media titles and the media samples are made available to customers via the web site 22. The database server 13 provides search services for the web site 22 allowing search parameters such as titles, individual names in the credits' and rating. The media samples will typically be small subsets of the media files available for sale and will usually in a different format more suitable for downloading or streaming across the Internet. For instance, a representative media file may be stored in a non-compressed high quality format suitable for creating quality recordings, while the sample will be highly compressed and at a lower resolution. A more specific example would be a video where the original file is in an AVI 720×480 format using a DV encoder and the sample is in an AVI 320×240 format using an Intel 504 encoder with the quality factor set to 50%.

The recording database component of the database server 13 includes information about each recording made on the system. The information includes an array of indices into the media file database indicating the media files used for the recording, the customization options applied, an index into the customer database pointing to the customer who placed the order, the date and time the order was placed, the shipping date of the order, the media type, any error conditions that may have occurred during the recording, the initials of the quality control inspector responsible for checking the recording prior to shipment, and the serial number of the media onto which the recording was made. If the manufacturer services more than one media producer, the name of the producer would also be included. The date of the order and the shipping date are tracked for quality control purposes, resolving customer complaints, and providing an indication of when the size of the system should be increased to ensure prompt delivery of orders.

The digital ID generator software application referencing the recording database component of the database server 13 creates a unique digital identification number that may later be used to reference the recording database entry associated with a particular recording. While the final format of the digital ID is not purported to be contained within the invention, the basic algorithm for generating the ID is. In addition to the recording database reference, the digital ID will also contain information about the manufacturer, the media producer, and the media type. The digital ID will be a combination of letters and numbers. Letters are suggested for manufacturer and media producer as these will be suitable for easy human recognition, with 3 letters assigned to a manufacturer and four to a producer. A 48 bit binary or 12 digit hexadecimal number should be more than adequate for the media file reference index. The customer who purchased the media recording can be traced by using the media file reference index to locate the associated record within the media recording database, the using the customer index therein to reference the record for that customer within the customer database.

The recording mechanism 14 includes a job-control master computer system 28, media file archival server 34, and a plurality of media file clusters 32. These will be described in more detail below.

The job-control master computer system 28 may be any suitable computer server system running a modern operating system, such as Windows 2000 or a recent incarnation of UNIX, that is able to efficiently function as a network file server, support at least two network adapters and run multiple simultaneous processes. The job-control master computer system 28 needs to manage the recording jobs (the media files and customizations selected by the customers to be purchased) by maximizing the utilization of the recording mechanism 14. Orders from website 22 are entered into a customer order queue on the job-control master computer system 28.

Upon retrieval of a job from the customer order queue, the job-control master computer system 28 evaluates a plurality of processing job queues based on a number of factors including minimizing network file accesses, balancing processing loads among the recording clusters 32 and speediest methods of completing a particular job. A processing job queue is present on each media file master server in a recording cluster 32. Other factors used in determining which recording cluster 32 a job is sent to include how many jobs are already in the processing job queue for that particular recording cluster 32, past jobs that were executed, and the configuration of the cluster. The past jobs are an important factor because data transfer times may be reduced if a media file is already in the local storage of a certain client system or existing on a media file master server 30 within a particular recording cluster 32. However, if too many jobs are on a particular queue, the current job will be assigned to a less busy queue. Some recording clusters 32 may be designated to work primarily on jobs using media files that are most frequently referenced, such as jobs involving duplication of the most popular media choices. In these cases, the client systems may have additional storage capacity to allow more media files to be stored locally. Other recording clusters may be configured to work primarily on jobs requiring greater amounts of computation or that require a particular media format.

Once a recording cluster has been designated to receive a recording job, the job-control master 28 copies the information required for completing a particular recording job to the media file master 30 associated with the recording cluster. Once the information has been copied, the job is placed on the processing queue of the recording cluster 32. This information includes references to the media files necessary to make the recording, the customization options chosen by the customer, any uploaded files to be used in the customization, and any data items necessary for printing the packaging and labels for the recording.

Communication between the job control master 28 and the plurality of media file master 30 computer systems occurs using the job control and archival network 46. This network also must support communications between the plurality of media file master 30 computer systems and the media file archival server 34, as well as communications between the plurality of media file master 30 computer systems and the database server 24. As the job control and archival network 46 must support a potentially high volume of media file transfers. Larger scale embodiments of the invention will require a high bandwidth network such as Gigabit Ethernet, while 100 Mbps Ethernet may be sufficient in smaller scale embodiments.

The plurality of media file master servers 30 supply media files only to the plurality of client systems associated with a particular media file master server 30. The plurality of media file master servers 30 may assign a higher storage priority to media files that are the most popular customer selections. This allows for quicker access to these media files and, therefore, less time consumed to obtain the media files. Media files not present within the storage of a cluster may be retrieved from a media file archival server 34 on an as needed basis. Less popular media files will be given a lower storage priority and thus will be more prone to being erased to free space on an as needed basis by the media file master servers 30. The media files may be compressed to save storage space or compressed due to the nature of the file type, in which case a client system must decompress the files prior to processing and possibly recording. The media files may also be encrypted when stored on the media file master server 30 and media file archival server 34 to protect against piracy. If the media files are encrypted, the client systems must decrypt the files prior to processing or recording.

The plurality of recording clusters 32 may contain media generation clients 36, packaging printer clients 37 and media-recording clients 38. The processing of jobs within a recording cluster 32, the media generation client 36, the packaging printer client 37 and the media-recording client 38 are described in more detail below.

Up to four queues are maintained within each recording cluster by the media file master server 30 associated with that cluster. One of the queues is the processing queue as was described above. If required for the types of media being generated, a generation queue is utilized for computational jobs to be processed by the generation clients 36 within the recording cluster 32. An example of where generation clients would likely not be needed is for the recording of music files. An example of where generation clients are highly needed is where video files require customization prior to recording. A recording queue is utilized for recording jobs to be processed by the recording clients 38 within the cluster. A packaging printer queue is utilized for printing jobs for the packaging that will be used for the completed recording.

The media file master server 30 is responsible for placing jobs on the generation queue, the packaging printer queue and the recording queue based on the jobs it receives in its processing queue. Upon retrieving a job from the processing queue, the media file master server 30 checks to see if the files required for the job are in its storage used for serving files to the clients within the recording cluster. If the files are not present, they are retrieved from the media file archival server 34 or the database server 13 in the case of an uploaded file. If there is not enough space for the files, other non-locked files are removed to make space for the new files. Once the files are present, they are locked to prevent them from being removed before the job has been completed. The media file master server 30 then places the job on the generation queue or the recording queue as the case may be. The media file master server 30 also places a job on the packaging printer queue along, with each entry containing an estimated time for the completion of the recording job.

All four queues have similar requirements and may be implemented with the same underlying software, though with some differences as will be described. Each job entry in any of the queues will have a status word associated with it indicating the current state of the job. In the case of the processing queue, the states will include “unprocessed”, “media files being fetched”, “generating”, “recording”, “recording & printing”, “complete”, “recoverable error condition” and “non-recoverable error condition”. A job entry is removed from the processing queue as well as any of the other queues only in the cases of “complete” and “unrecoverable error condition”. The states for the generation queue will include “unprocessed”, “generating”, “complete”, “recoverable error condition” and “non-recoverable error condition”. When in the “generating” state, information will be added to the status data to indicate which generation client 36 is processing the job. The states for the recording queue will include “unprocessed”, “recording”, “complete”, “recoverable error condition” and “non-recoverable error condition”. When in the “recording” state, information will be added to the status data to indicate which media recording client 38 is processing the job. The states for the package printing queue will include “unprocessed”, “printing”, “complete”, “recoverable error condition” and “non-recoverable error condition”. When in the “printing” state, information will be added to the status data to indicate which package printing client 37 is processing the job. When either the media file master 30 or a client system is ready to change the state indication of a status word, the status word must first be locked allowing only that system to change the status word. This is necessary to prevent a race condition from occurring among the plurality of computer systems and processes accessing each queue.

Each recording cluster will have a dedicated media network 44 to provide communications between the media file master 30 and the plurality of generation clients 36, the plurality of recording clients 38 and plurality of printing clients 37. In most embodiments of the invention, there will be a plurality of media networks 44 allowing an extremely high aggregate bandwidth to be attained. As the media network 44 must support a high volume of media file transfers, the media network must be implemented with a high bandwidth network such as Gigabit Ethernet.

The media generation client 36 may be any suitable high performance, low cost computer system running a modern operating system, such as Windows 2000 or Linux. In the preferred embodiment, the generation client 36 will be a PC configured with one or more late generation Intel processors, large memory and running a recent generation of a workstation class version of Windows, such as Windows 2000, due to it's optimal performance for computations. The media generation client 36 retrieves a generation job from the generation queue when the media generation client 36 becomes available. Once a generation job has been accepted, the associated status word in the generation queue is changed to indicate the generation job is currently being processed. The media generation client 36 generates a plurality of possibly unique customized files to be recorded. As a customized file a customer may desire to have their uploaded picture on a billboard in a segment of the movie, removal of objectionable scenes, their names listed on the billings, their uploaded voice file dubbed into a song or other such customizations. The media generation client 36 determines if the master files are already in local storage. If the media generation client 36 does not locate the master files in the local storage space, the media generation client 36 requests the media file(s) from the master server 30. Once all the master files are available, the media generation client 36 picks up the job and computes the new customized files. One customization the generation client may apply is to insert an invisible digital identifier into the media files based on the identifier created by the digital ID generator. The digital identifier may be inserted by a media-recording client if the computational expense is low, as would be the case with audio files. The customized files are stored in a temporary area on the media file master server 30 as they are computed. The generation client 36 indicates to the media file master server 30 that the generation job is complete by changing the associated status word in the generation queue. The locks may be removed from be removed from the associated master files at this time if not required for the recording job.

The media recording client 38 may be any suitable high performance, low cost computer system running a modern operating system, such as Windows ME, or Linux. In the preferred embodiment, the recording client 38 will be a PC configured with a late generation Intel processor, a medium amount of memory, disk drives with performance sufficient to support the type of recording devices currently attached, a high bandwidth network interface, the required media recording interface(s) and running a recent version of a consumer version of Windows due to the large number of media recording devices supported. The media-recording client 38 has one or more media recorders 40 attached. When the media-recording client 38 becomes available, a record job assignment is retrieved from the recording queue on the associated media file master server 30. Once the required media file(s) are ready, the media recording client 38 requests a recordable media source to be inserted into a recording device 40. When the recordable media item is inserted into the recording device 40, the unique identification number generated by the digital ID generator is noted and the recording proceeds. Once the recording is completed, the media recording client indicates to the associated media file master server 30 that the job has been completed by changing the associated status word in the recording queue. The media file master server 30 removes the locks from the associated files and changes the status of the associated processing queue job entry to indicate it has been completed. Additionally, the unique identification number and other identifying information such as media item bar code number are sent back to the database server 13 to be placed in the records associated with the particular recording. The media-recording client 38 causes the recordable media item to be ejected from the recording device 40.

The packaging printer client 37 may be any suitable computer system capable of supporting a plurality of photo quality color graphics printers, of computing modified photo quality graphics and of simultaneously printing on all of them. In the preferred embodiment, the printing client 37 will be a PC configured with a late generation Intel processor, a medium amount of memory, medium capacity disk drives, a high bandwidth network interface, interface port(s) capable of supporting several photo quality color graphics printers, and running a recent generation of a server version of Windows. When a printer attached to the packaging printer client 37 becomes available, a job assignment is retrieved from the package printing queue on the associated media file master server 30. The packaging printer client must first generate or modify the graphic images and text associated with the recording. The attached printers may be any photo quality color printers capable of printing on packaging insert material of the type and size required for the media format being recorded, or may be label printers used for printing text and simple graphics on stick-on labels. The packaging insert material may be glossy paper suitable for inserting into the label area of a plastic container for the media. In the preferred embodiment, the inks used for printing the insert and/or labels will be waterproof.

The media file archival server 34 may be any suitable computer server system running a modern operating system, such as Windows 2000 or a recent incarnation of UNIX, that is able to efficiently function as a network file server, support at least two network adapters, run multiple simultaneous processes and support a large amount of online and offline storage. The server may be required to contain terabytes of online storage and tens of terabytes of offline storage. The online storage should be large enough to store a high percentage of the media titles available for sell. The offline storage is primarily for backup and to store seldom purchased titles.

The shipping mechanism 16 may include a packaging mechanism 42 and a shipment mode 44. These will be described in more detail below. The packaging mechanism 42 may be any suitable packaging mechanism such as robots, machines, or people. At this stage, two types of packaging occurs, one being the product packaging in containers similar to that found in stores and the other being the packaging required for shipping. The product packaging may be plastic containers or boxes suitable for providing a professional and finished appearance to the recorded media. The shipping packaging may be envelopes, boxes, or other suitable shipping package for the various recordable media types. The packaging insert generated by the packaging printer client 37 is inserted or attached to the product packaging. Any stick-on labels are applied to the media itself. The media is then packaged for shipping and the shipping label is attached to the outer surface of the packaging. The product and shipping labels may be attached by robotics, machines, or people. The shipment mode 44 may be any suitable shipment mode such as the United Parcel Service or Federal Express or other suitable transportation. The tracking number associated with the shipment is recorded into the recording database on the database server 24.

Although the present invention has been described with reference to preferred embodiments, workers skilled in the art will recognize changes may be made in form and detail without departing from the spirit and scope of the invention.

1. A media provider system, comprising:
a user interface, the user interface being a web site that allows the user to preview, select and purchase media files;
a customer database capable of holding data or information about a plurality of customers, such information including name, shipping address, billing address, media preferences, past purchases, and payment information;
a media database containing information about a plurality of media files available for purchase, such information including cost, length, available formats, ratings, credits, ownership, royalty requirements, and representative samples of each media file to be used for customer previews and selection of customization options;
a recording database containing information about a plurality of recordings made by the system, such information including recording number, media serial number, time and date of the recording, and a reference key to the customer record in the customer database for the purchaser of the recording;
at least one database server containing the customer, media and recording databases;
at least one media file customization server for computing customizations on media file samples for the web site;
a digital ID generation software application referencing the customer database, the digital ID generation software application generating unique digital identification numbers that reference purchases in the recording database;
a job-control master computer system, the job-control master computer system managing the duplication jobs, the job control master directing each duplication job to a processing job queue of a particular recording cluster based on efficiency principles;
a media file archival server storing less popular media files and allowing for backup of the media files;
a plurality of media file clusters each containing a media file master server, a processing job queue, at least one media generation client, a generation queue, at least one package printing client, a package printing queue, at least one media-recording client, a recording queue and a media network; the media file master server obtaining a job from the processing job queue, acquiring files for the job in at least one area consisting of a media master file server local storage and the media file archival server, the media master file server sending the jobs requiring customization work to the generation queue and sending jobs not requiring customization work to the recording queue, the media generation client retrieving the job from the generation queue, performing customization work and returning the job to the master media file server, the media recording client retrieving the job from the recording queue and duplicating the files together with the unique digital identification number on a recording medium;
a web site network allowing for communications between the web site server, database server(s) and job control master computer system; and
a job control and archival network allowing for communications between the database server(s), the job control master computer system, the media file archival server and a plurality of media file clusters.

2. A media provider system, comprising:
a plurality of media file clusters each containing a media file master server and at least one media-recording client; the media file master server acquiring customized files for a particular duplication job and sending the files for a job to a recording queue, the media recording client retrieving a job from the recording queue and duplicating the files;
a job-control master computer system, the job-control master computer system sending a duplication job to one of the media file clusters; and
a media network used for communications between the media file master server. and a plurality of client systems within the media file cluster.

3. The media provider system of claim 2 further comprising:
at least one media generation client and a generation queue, the generation queue receiving jobs from the media file master server that require customization, the media generation client retrieving a job from the generation queue, customizing the files and sending customized jobs to the recording queue.

4. The media provider system of claim 2 further comprising:
at least one packaging printer client and a packaging printer queue, the packaging printer queue receiving jobs from the media file master server that allow for printing of labels and inserts to be used in the product packaging for the completed recording.

5. The media provider system of claim 3 wherein the customized job is communicated to the recording queue via the media file master server.

6. The media provider system of claim 2 further comprising:
a user interface, the user interface being a web site and communicating jobs to the job control master;
a customer database capable of holding data or information about a plurality of customers, such information including name, shipping address, billing address, media preferences: past purchases, and payment information;
at least one database server containing the customer database; and
a web site network allowing for communications between the web site server, and the database server(s).

7. The media provider system of claim 6 further comprising a media database containing information about a plurality of media files available for purchase, such information including cost, length, available formats, ratings, credits, ownership, royalty requirements, and representative samples of each media file to be Used for customer previews and selection of customization options.

8. The media provider system of claim 6 further comprising a recording database containing information about a plurality of recordings made by the system, such information including recording number, media serial number, time and date of the recording, and a reference key to the customer record in the customer database for the purchaser of the recording.

9. The media provider system of claim 7 further comprising at least one media file customization server for computing customizations on media file samples for the web site.

10. The media provider system of claim 2 further comprising:
a job control master computer system that directs each recording job to a particular recording cluster based on efficiency principles; and
a job control network allowing for communications between the job control master computer system and a plurality of media file clusters.

11. The media provider system of claim 2 further comprising:
a media file archival server that obtains files in at least one area from the group consisting of local storage and the media file archival servers.; and
an archival network allowing for communications between the media file archival server and a plurality of media file clusters.

12. The media provider system of claim 8 wherein the media recording client places a customer specific digital identifier on recorded copies.

13. The media provider system of claim 2 wherein the files include at least one member selected from the group consisting of videos, games, electronic pictures and sound recordings.

14. The media provider system of claim 2 wherein at least one recording cluster is strictly for recording popular media choices.

15. The media provider system of claim 2 wherein the media files are encrypted.

16. The media provider system of claim 2 further comprising a recorder, the media recording client controlling the recorder with respect to insertion of, recording to and removal of a recording medium.

17. The media provider system of claim 2 wherein the files are recorded on a recording medium selected from the group consisting of cassette tapes, DVDs, CDROMs, floppy discs, and video tapes.

18. The media provider system of claim 2 wherein multiple types of media files are recorded on one specimen of a recording medium.

19. The media provider system of claim 2 wherein each media file master server maintains several media files that are the more popular customer selections.

20. The media provider system of claim 2 further comprising a media generation client, the media file master server sending a job requiring a computation to the media generation client.

21. The media provider system of claim 3 wherein the media generation client performs computations on media files, modifies media files and generates media files.

22. The media provider system of claim 22 wherein the media generation client sends the files for a job to the recording queue.

23. The media provider system of claim 6 further comprising:
a downloadable applet for a web browser allowing media file customization options to be interactively computed, previewed and selected; and
transmission of customization option selections from the applet to the web site.

24. A method of recording, comprising:
selecting one or more media content files for recording from a plurality of available media content files;
imputing a job including media content selections and customization requirements;
transmitting the job to a processing job queue of a selected media cluster;
acquiring the files for the job;
customizing the files;
recording the files onto recordable media; and
printing packaging inserts and labels for the recording.

25. The method of claim 24 wherein the step of customizing further comprises:
sending the job to a generation queue;
updating the job entry status on the generation queue to indicate the job is being worked on;
performing customizations on the files of the job;
updating the job entry status on the generation queue to indicate the job is completed; and
returning the job to the processing job queue.

26. The method of claim 24 wherein the step of recording further comprises:
sending the job to a recording queue;
updating the job entry status on the recording queue to indicate the job is being worked on;
recording the files onto recordable media;
updating the job entry status on the recording queue to indicate the job is completed; and
updating the job entry status on the processing queue to indicate the job is completed.

27. The method of claim 24 wherein the step of selecting one or more media content files further comprises:
putting information about available media content files on a web site;
sending code and data to a web browser for the purposes of displaying information about available media content files; and
sending code and data to a web browser for the purposes of allowing a customer to specify one or more media file selections for purchase.

28. The method of claim 27 wherein the data sent to a web browser includes media file samples.

29. The method of claim 27 wherein the code sent to a web browser includes applets for computing and presenting examples of media file customizations.

30. The method of claim 27 further comprising the step of a media file customization. server providing computational services for the web site.

31. The method of claim 24 wherein the step of transmitting the job to a processing job queue of a selected media cluster further comprises:
determining which media files are required for the job;
estimating the computational time for the customizations required for the job;
determining the jobs currently running on a plurality of media clusters;
determining the jobs that have run recently on a plurality of media clusters;
determining which media files are present in the local storage areas for a plurality of media clusters; and
selecting a media cluster that is likeliest to complete the recording job in the shortest amount of time.

32. The method of claim 31 further comprising the step of determining whether the media files are a popular choice.

33. The method of claim 32 wherein the step of selecting a media cluster further comprises the criteria of selecting a media cluster designated for recording popular titles.

34. The method of claim 24 wherein the step of acquiring the files further comprises retrieving the files from a media file archival server if the files are not present in the local storage of the selected media file cluster.
